(19) United States
(12) Patent Application Publication
(10) Pub. No.: US 2010/0167057 A1
(43) Pub. Date: Jul. 1, 2010

(54) MAGNETIC NANOPARTICLES, MAGNETIC AND FLUORESCENT NANOCOMPOSITE, AND FORMATION OF MAGHEMITE BY OXIDIZING IRON STEARATE WITH METHYLMORPHOLINE N-OXIDE

(75) Inventors: Jackie Y. Ying, Singapore (SG); Subramanian Tamil Selvan, Singapore (SG)

Correspondence Address: KLARQUIST SPARKMAN, LLP, 121 SW SALMON STREET, SUITE 1600, PORTLAND, OR, 97204, US

(73) Assignee: Agency for Science Technology and Research

(21) Appl. No.: 12/666,613

(22) PCT Filed: Jun. 27, 2008
(86) PCT No.: PCT/SG2008/000229

§ 371 Date: Dec. 23, 2009

Related U.S. Application Data
(60) Provisional application No. 60/929,438, filed on Jun. 27, 2007.

(51) Int. Cl. C09K 11/00; C01G 49/06; H01F 1/01

(52) U.S. Cl. 428/402; 423/634; 252/62.56; 977/773; 977/774

(57) ABSTRACT

Maghemite (γ-Fe₂O₃) is formed by oxidizing iron stearate with methylmorpholine N-oxide (MNO). A mixture comprising iron stearate, MNO, a surfactant, and a solvent may be heated to maintain the mixture at a temperature of about 280 to about 320° C. for a sufficient period to form magnetic nanoparticles comprise maghemite. After heating, the mixture may be cooled to limit growth in size of the nanoparticles. The mixture may be heated for a period of about 15 minutes to about 30 minutes, such as about 15 minutes. The process may be adapted to also form quantum dots, and to form magnetic quantum dot (MQD) nanoparticles in an integrated process.

### CROSS-REFERENCE TO RELATED APPLICATION

This application claims the benefit of U.S. provisional application No. 60/929,438, filed Jun. 27, 2007, the contents of which are incorporated herein by reference.

### FIELD OF THE INVENTION

The present invention relates to magnetic nanoparticles, and magnetic and fluorescent nanocomposites, particularly those comprising maghemite, and methods of forming these particles.

### BACKGROUND OF THE INVENTION

Magnetic nanoparticles (MP), and nanocomposite of MP and quantum dots (QD), are useful in many different applications, such as bio-labeling, imaging, cell sorting or separation, drug targeting, and the like. MP having particle sizes less than 15 nm can display superparamagnetic characteristics and are useful in applications such as spintronics and magnetic resonance imaging. Nanocomposites of MP and QD (MQD) are both magnetic and fluorescent and are convenient to use when both these functionalities are needed.

One technique for forming MPs is to use iron pentacarbonyl (Fe(CO)₃) or iron acetylacetonate, to form nanoparticles of iron oxide (γ-Fe₂O₃), also known as maghemite. However, the iron pentacarbonyl or iron acetylacetonate precursor is hazardous. Further, this technique uses trimethylamine N-oxide ((Me)₃N(O)) as the oxidant, which is relatively expensive. Thus, it is desirable to provide a relatively less expensive and safer process for producing maghemite nanoparticles.

There have also been attempts to produce MQD. However, the reported fluorescence quantum yield of MQD is relatively low, in the range of about 3-18% in a growth solution. The fluorescence quantum yield is the ratio of the number of photons emitted to the number of photons absorbed. MQD with a low quantum yield has limited commercial application. It is desirable to produce MQD with a higher quantum yield.

### SUMMARY OF THE INVENTION

In accordance with an aspect of the present invention, there is provided a method of forming maghemite, comprising oxidizing iron stearate (Fe(St)₂) with methylmorpholine N-oxide (MNO), to form maghemite (γ-Fe₂O₃). The oxidation may comprise heating a mixture comprising iron stearate, MNO, a surfactant, and a solvent to maintain the mixture at a temperature of about 280 to about 320° C., such as about 300° C., for a sufficient period to form magnetic nanoparticles. The nanoparticles comprise the maghemite. After the heating, the mixture is cooled to limit growth in size of the nanoparticles. The mixture may be heated for a period of about 15 minutes to about 30 minutes, such as about 15 minutes. The mixture may be heated under an argon gas. The surfactant may comprise octadeylamine (ODA). The solvent may be octadecene (ODE). The weight ratio of iron stearate to MNO in the mixture may be about 1:1 to about 2:1, such as about 2.3:1. The weight ratio of iron stearate to the surfactant in the mixture may be about 2.3:1. The mixture may be cooled to a temperature of about 30 to about 40° C. After the cooling, the nanoparticles may be washed with a solution comprising cyclohexane and acetone.

In the method described in the preceding paragraph, the mixture may further comprise cadmium stearate (Cd(St)₂). The surfactant may comprise trioctylphosphine oxide (TOPO). The cadmium stearate may be formed by reacting cadmium oxide (CdO) with a stearic acid. The mixture may initially comprise CdO and stearic acid, and the molar ratio of CdO to Fe(St)₂ in the mixture may be from about 10:1 to about 2:1, such as from about 10:1 to about 5:1. Subsequent to the cooling, Selenium (Se) may be added to the mixture to react Cd(St)₂ with Se to form CdSe quantum dots (QD); the nanoparticles and QD may be dissolved in a first solvent, and re-precipitated in a second solvent to form a nanocomposite comprising both the maghemite and the QD. The heating temperature may be about 300° C., and the cooling may comprise cooling the mixture to a temperature of about 280° C. The first solvent may be chloroform, and the second solvent may be methanol. The Se may be dissolved in trioctylphosphine (TOP) prior to being added to the mixture.

In accordance with a further aspect of the present invention, there is provided a composite comprising a particle comprising maghemite and a CdSe quantum dot and having an average particle size of less than 100 nm. The composite is magnetic and exhibits a fluorescence quantum yield of above 18%, such as about 42%. The average particle size may be less than about 10 nm. The composite may comprise a plurality of magnetic and fluorescent particles. The particles may be formed according to the method described in the preceding paragraph.

In accordance with another aspect of the present invention, there are provided nanoparticles comprising maghemite formed according to the method described in the preceding paragraphs under this section.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic diagram of a process for forming magnetic nanoparticles, exemplary of an embodiment of the present invention;

FIG. 2 is a line graph of the XRD pattern of sample nanoparticles formed according the process of FIG. 1;

FIGS. 3 and 4 are TEM images of the sample nanoparticles formed according to the process of FIG. 1; with different magnification factors;

FIG. 5 is a schematic diagram of a process for forming magnetic and fluorescent nanocomposite, exemplary of another embodiment of the present invention;

FIGS. 6, 7, and 8 are TEM images of sample nanocomposites formed according to the process of FIG. 5; with different magnification factors;

FIG. 9 is a line graph of the photoluminescence spectra for different nanocomposites formed according to the process of FIG. 5;

FIG. 10 is a data graph showing the magnetization of sample nanoparticles formed according to the processes of FIG. 1 or FIG. 5;

FIG. 11 is a data graph showing the ZFC and FC magnetization of sample nanoparticles and nanocomposite, formed according to the process of FIG. 1 or FIG. 5; and

FIG. 12 is a line graph showing absorbance of sample nanocomposites formed according to the process of FIG. 5.

### DETAILED DESCRIPTION

In brief overview, it is discovered that maghemite can be conveniently formed by oxidizing iron stearate with methylmorpholine N-oxide. The resulting maghemite may be in the form of nanoparticles and may have a nanocrystal structure.

For forming the desired maghemite nanocrystals, a surfactant, such as octadeylamine (ODA), is also mixed with the reactants. The ODA can provide a ligand source to cap the surface of formed nanocrystals and reduce undesired aggregation and over-growth of the particles.

For the oxidation reaction to proceed at a suitable rate, the reaction temperature may be maintained within a range from about 280 to about 320° C. For forming nanoparticles with a desired size distribution, the reaction temperature may be selected and maintained for a sufficient period of time to allow the particles to form and grow in size. After the selected period of heating, the mixture may be cooled to limit growth in size of the nanoparticles.

In an exemplary process, a mixture including iron stearate (Fe(St)₂), methylmorpholine N-oxide (MNO), octadecyl amine (ODA), and a solvent is heated to, and maintained at, a temperature of about 300° C., for about 15 to about 30 minutes. The solvent may be a non-coordinating organic solvent such as octadecene (ODE). After heating, the mixture is cooled to a lower temperature, e.g., in the range of about 30 to about 40° C. The cooled mixture contains magnetic nanoparticles that include maghemite (γ-Fe₂O₃). The nanoparticles may be extracted from the mixture by washing the mixture and the nanoparticles therein with a solution of cyclohexane and acetone (their volume ratio may be from about 1:3 to about 1:5. In one embodiment, the volume ratio of cyclohexane to acetone may be 3:2. In different embodiments, a different washing solution may be used. For example, chloroform and methanol may be used.

For forming iron oxide particles, the weight ratio of iron stearate to MNO in the reaction mixture may be about 1:1 to about 2:1, such as about 2.3:1, and the weight ratio of iron stearate to ODA in the reaction mixture may be about 2.3:1. With a higher concentration of ODA in the reaction mixture, the quality of the nanocrystals formed may be improved.

In different embodiments, another long chain amine may be used as the surfactant instead of ODA. For example, hexadeylamine (HDA) may be used as the surfactant.

As can be appreciated, the reagents used in this process, including MNO, are non-toxic and are relatively inexpensive.

Conveniently, the above process can be integrated with a process for forming quantum dots to produce magnetic quantum dots (MQDs) in an integrated process. In an exemplary embodiment of the present invention, the integrated process may be performed as follows.

Suitable amounts of Cadmium stearate (Cd(St)₂) and trioctylphosphine oxide (TOPO) may be additionally added to the initial mixture discussed above before the mixture is heated to the selected temperature, such as about 300° C. The Cd(St)₂ added to the mixture may be formed by reacting cadmium oxide (CdO) with a stearic (octadecanoic) acid, and may be formed in situ within the mixture by adding CdO to the initial mixture and heating the mixture to about 150° C. In one embodiment, the initial molar ratio of CdO to Fe(St)₂ in the mixture may vary from about 10:1 to about 5:1. In another embodiment, the molar ratio of CdO to Fe(St)₂ in the mixture may vary from about 5:1 to about 2:1.

For the synthesis of bifunctional Fe₂O₃—CdSe MQDs, excess surfactants (such as ODA and TOPO) are added. As both ODA and TOPO can serve as a surfactant, in some applications, only one surfactant such as TOPO may be sufficient and ODA may be omitted.

After the mixture has been heated to the selected temperature such as about 300° C. and then cooled back to about 280° C., selenium (Se) is added to the cooled mixture to react with the Cd(St)₂ to form CdSe quantum dots. Se may be dissolved in trioctylphosphine (TOP) before being added to the mixture. The cooled mixture contains nanoparticles and quantum dots, which are dissolved in a first solvent such as chloroform and are then re-precipitated in a second solvent such as methanol.

In different embodiments, chloroform may be replaced by another solvent such as toluene, cyclohexane, or the like; and methanol may be replaced by another solvent such as acetone, ethanol or the like.

The dissolution and re-precipitation cycle may be repeated a number of times, such as two to three times. The final precipitation contains nanocomposite of maghemite and CdSe QD.

The composite may contain particles formed of maghemite and CdSe quantum dots. The average particle size may be less than 100 nm (thus referred to as nanoparticles). Depending on the exact steps taken and the reagents used, the average particle size may be less than about 10 nm. The particle sizes may be controlled by adjusting the reaction temperature and reaction (growth) time. Techniques for controlling the sizes of the particles and the quantum dots can be readily understood and developed by those skilled in the art. For example, the reactions may be carried out in a Schlenk™ line which has three or five manifolds to control Ar purging and create vacuum inside the reaction flask. For further details of exemplary size control techniques, see, e.g., C. B. Murray, D. J. Norris, M. G. Bawendi, J. Am. Chem. Soc., 1993, 115, 8706-8715; M. A. Hines, P. Guyot-Sionnest, J. Phys. Chem., 1996, 100, 468-471; B. O. Dabbousi, J. Rodriguez-Viejo, F. V. Mikulec, J. R. Heine, H. Mattoussi, R. Ober, K. F. Jensen, M. G. Bawendi, J. Phys. Chem. B, 1997, 101, 9463-9475; D. V. Talapin, A. L. Rogach, A. Komowski, M. Haase, H. Weller, Nano Lett., 2001, 1, 207-211; X. Peng, Chem. Eur. J., 2002, 8, 334-339; C. B. Murray, C. R. Kagan, M. G. Bawendi, Ann. Rev. Mater. Sci., 2000, 30, 545-610, the entire contents of each of which are incorporated herein by reference.

The composite is both magnetic and exhibits a fluorescence quantum yield of above 18%, such as up to about 42%.

Conveniently, in the processes described above it is not necessary to use iron pentacarbonyl (Fe(CO)₅) or iron acetylacetonate as the precursor, which can be hazardous. Further, bi-functional magnetic quantum dots (MQDs) containing fluorescent quantum dots (QDs) and γ-Fe₂O₃ magnetic nanoparticles (MPs) can be conveniently synthesized in a single reaction container. The MNO conveniently serves as an oxidizing agent in both the formation of the MPs and the QDs. It is not necessary to use the more expensive oxidant trimethylamine N-oxide (Me)₃N(O)). The exemplary embodiment described herein can also be conveniently adapted to produce the nanocrystals in large quantities.

The above process can be modified to form MQDs that contain other QDs than CdSe. For example, the process may be adapted to produce nanoparticles that contain other semiconducting nanoparticles or QDs, such as CdTe, CdS, or the like, and the MPs. The process may also be modified to make the MQDs water soluble using a suitable technology, such as that described in S. T. Selvan, P. K. Patra, C. Y. Ang, J. Y. Ying, Angew. Chem. Int. Ed. 2007, vol. 46, pp. 2448-2452, the entire content of which is incorporated herein by reference.

Advantageously, the quantum yield in the exemplary processes described herein can be as high as about 42% and various desirable magnetic properties may be obtained.

Nanocomposites of MPs and QDs have applications in various applications such as biolabeling/imaging, cell sorting/separation, and drug targeting. MPs with sizes of less than about 15 nm can display superparamagnetic characteristics, which may be useful for applications such as spintronics and magnetic resonance imaging (MRI).

### EXAMPLES

### Example I

### Synthesis of γ-Fe203 MPs

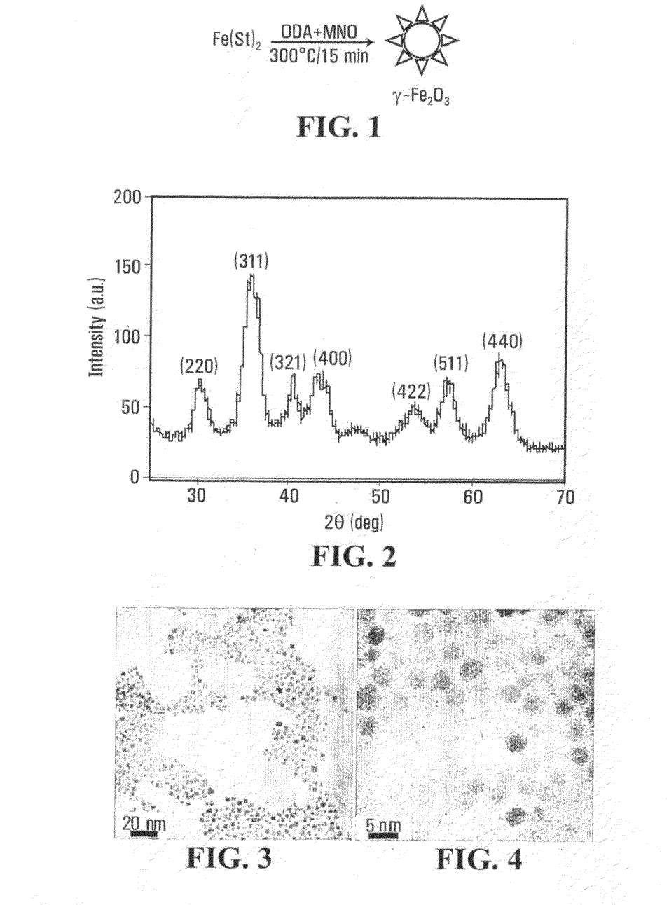

Sample γ-Fe₂O₃.MPs were synthesized according to the synthesis route schematically shown in FIG. 1.

Fe(St)2 (3.73 g), ODA (1.61 g), MNO (1.61 g) and ODE (90 mL) were mixed in a 250 mL container. The container was pumped to near vacuum and purged with argon for 15 to 30 minutes. The mixture in the container was next heated under argon to 300° C., and kept at this temperature for about 15 minutes. After the heating was terminated, the resulting mixture solution, which was of a brownish black color, was cooled to 30 to 40° C. Particles in the mixture were washed/purified with a mixture of cyclohexane/acetone (with a volume ratio of 1:5) in three centrifugation-redispersion cycles. The wet precipitate extracted from the mixture solution was stored in a glove box under vacuum. The total weight of the dried magnetic particles was 2.03 g.

The formed samples were examined using the X-ray diffraction (XRD) technique. Representative XRD measurement results are shown in FIG. 2. The XRD results confirmed that the MPs contained γ-Fe₂O₃.

The samples were also examined by transmission electron microscope (TEM), which showed that the MPs were monodispersed with an average particle diameter of about 6 nm. Representative TEM images of the samples at different magnification factors are shown in FIGS. 3 and 4.

### Example II

### Synthesis of Bifunctional γ-Fe203—CdSe MQDs)

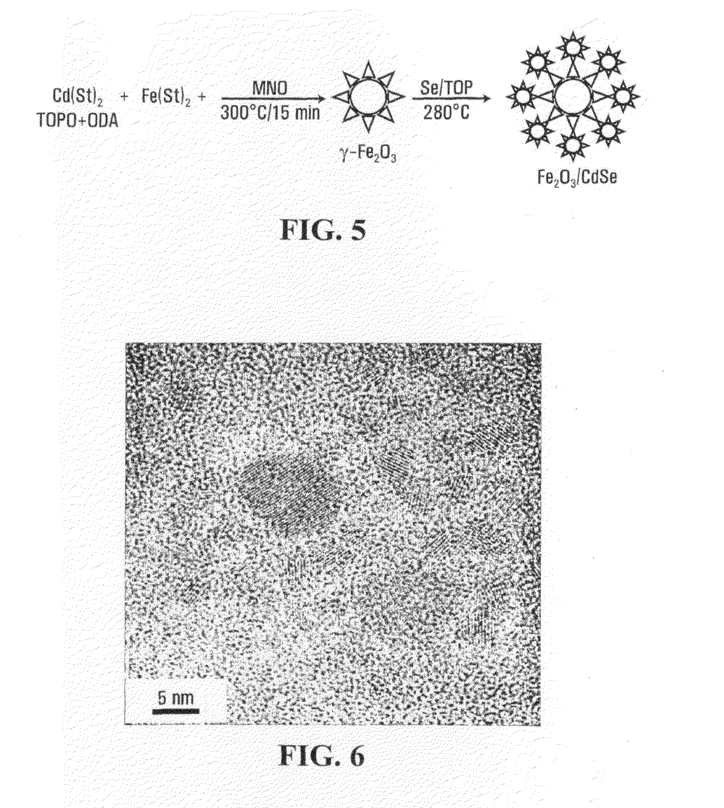

Sample Fe₂O₃CdSe MQDs were synthesized according to synthesis route schematically shown in FIG. 5 as follows.

Cadmium stearate (Cd(St)₂) was prepared according to the procedure described in L. Qu and X. Peng, “Control of Photoluminescence Properties of CdSe Nanocrytals in Growth,” J. Am. Chem. Soc., 2002, vol. 124, pp. 2049-2055, and Z. A. Peng and X. Peng, “Formation of High-Quality CdTe, CdSe, and CdS Nanocrystals Using CdO as Precursor,” J. Am. Chem. Soc., 2001, vol. 123, pp. 183-184, the entire contents of each of which are incorporated herein by reference.

Sample magnetic fluorescent nanocomposites were synthesized with iron stearate (Fe(St)₂), ODA and trioctylphosphine oxide (TOPO) using octadecene (ODE) as solvent and methylmorpholine N-oxide (MNO) as oxidant.

CdO (0.05 g) and stearic acid (0.46 g) were mixed in a container. The container was pumped to near vacuum for about 20 minutes. The mixture in the container was next heated under argon to 200° C. to form cadmium stearate, in accordance with procedure described above. The mixture was cooled down to about room temperature. Fe(St)₂ (0.05 g), ODA (8.71 g), TOPO (8 g) and MNO (0.012 g) were added into the container to form a further mixture. The new mixture was heated to 300° C., and kept at that temperature for about 15 minutes. The mixture was cooled to 280° C., and Se (0.32 g) dissolved in TOP (9.6 mL) was injected quickly into the container. Quantum dots and particles were allowed to grow in the mixture (a hot growth solution). For different samples, the growth period varied from 1 to 30 minutes. Aliquots were taken from the samples after the desired growth period. The hot growth solution was quenched in chloroform, followed by mixing with methanol (to form precipitation) and/or magnetic harvesting. The cycle of precipitation by mixing with methanol and redispersion in chloroform was repeated twice. The resulting precipitate was dried in a glove box.

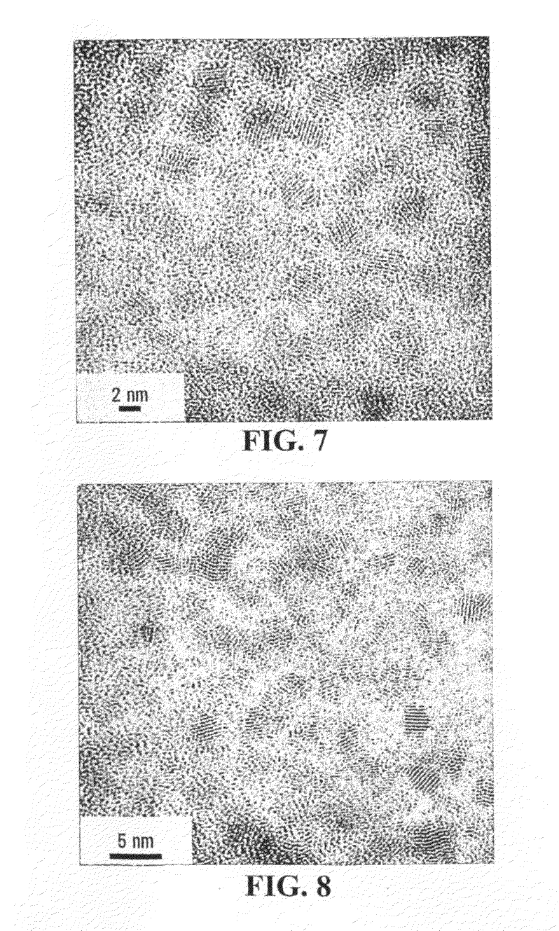

The magnetic and optical properties of the sample nanocomposites were adjusted by varying the molar ratio of CdO to Fe(St)₂ from about 5:1 to about 2:1. Representative TEM images of the samples obtained with different molar ratios are shown in FIGS. 6 (molar ratio=about 5:1), 7 (molar ratio=about 20:7) and 8 (molar ratio=about 2:1). As can be seen, at a CdO/Fe(St)₂ molar ratio of about 5:1, QDs and MPs were assembled as individual particles (see FIG. 6). MPs were encapsulated within a large population of QDs. As Se in trioctylphosphine (TOP) was injected swiftly at a higher temperature (280° C.), the homogeneous nucleation and growth of QDs, unassociated with the MPs, could not be excluded. At higher concentrations of Fe(St)₂, i.e. at a CdO/Fe(St)₂ molar ratio of about 20:7 or about 2:1, different structural features were observed in the TEM images (see FIGS. 7 and 8). In addition to heterodimers, there was a network structure composed of both MPs and QDs. The synthesized particles remained stable in non-polar solvents such as chloroform and hexane.

Addition of methanol destabilized the suspension, and both QDs and MPs were attracted to a magnet placed close to the suspension. When methanol was added, both the MPs and QDs were believed to be aggregated and separated by the magnet due to either heterodimer or network structure, or hydrophobic bilayer formation utilizing the interaction between ODA and TOPO. The aggregated particles that were both fluorescent and magnetic were re-dispersed in chloroform. The emission peaks of the solution became broader with growth time increased from 1-12 min to 25-30 min during the synthesis process, indicating particle aggregation induced by bilayer formation.

FIG. 6 indicated that the QDs were initially nucleated closer to the MPs, and with increased growth time, the QDs were well-separated. The average distance between the QDs and MPs was about 2 to 5 nm. The observed particle structures and the spacing between the particles were similar to those of CdSe/ZnS QDs and Fe₂O₃ MPs linked by thiol and carboxylic groups. With increased Fe(St)₂ concentration, the initially formed Fe₂O₃ acted as seeds for CdSe nucleation, resulting in hetero-dimers, finally leading to a network structure as the reaction proceeded further.

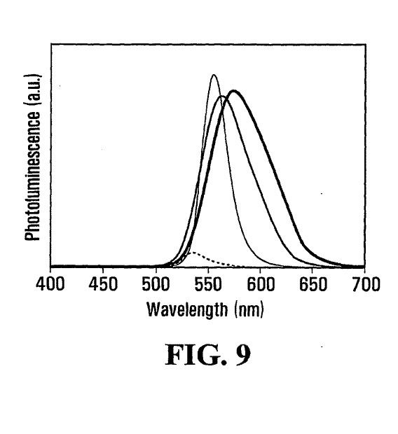

FIG. 9 shows the photoluminescence (PL) spectra of sample Fe₂O₃—CdSe MQDs formed after different growth periods. The sample MQDs were obtained with a CdO/Fe(St)₂ molar ratio of about 5:1. In the order of the peaks from left to right, the growth period for the spectrum lines in FIG. 9 was about 1, 12, 25 or 30 min respectively. The emission color of the sample MQDs in chloroform changed with the increase of growth time, from green (1 min), to greenish yellow (12 min), to yellow (25 min), and to red (30 min).

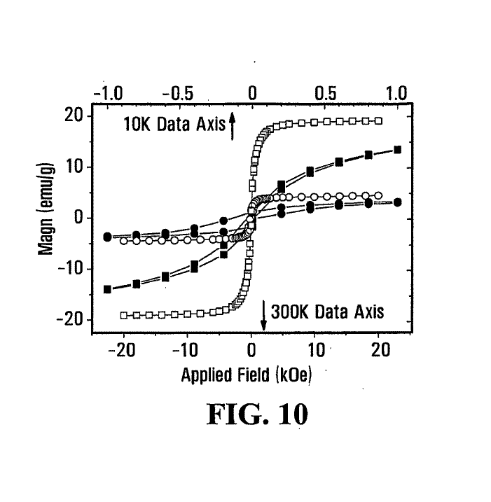

Magnetic properties of the sample particles were measured using a MPMS™ R2 magnetometer (by Quantum Design Co.™), which is a superconducting quantum interference device (SQUID). Representative measurement results of the field-dependent magnetization are shown in FIG. 10. The room temperature (300 K) data points are indicated by the open symbols and correspond to the bottom field axis. The 10 K data points are indicated by the solid symbols, and correspond to the top field axis, with circles representing data points measured from MPs and squires representing data points measured from MQDs. Both γ-Fe₂O₃₇ and Fe₂O₃—CdSe nanoparticles were found superparamagnetic at room temperature with saturation magnetizations (Mₛ) of 15 emu/g and 0.62 emu/g, respectively, at the maximum applied magnetic field of 50 kOe. At the temperature of 10 K, both samples exhibited hysteresis with coercive fields (H_{C}) of 40 Oe and 175 Oe, respectively (see FIG. 10).

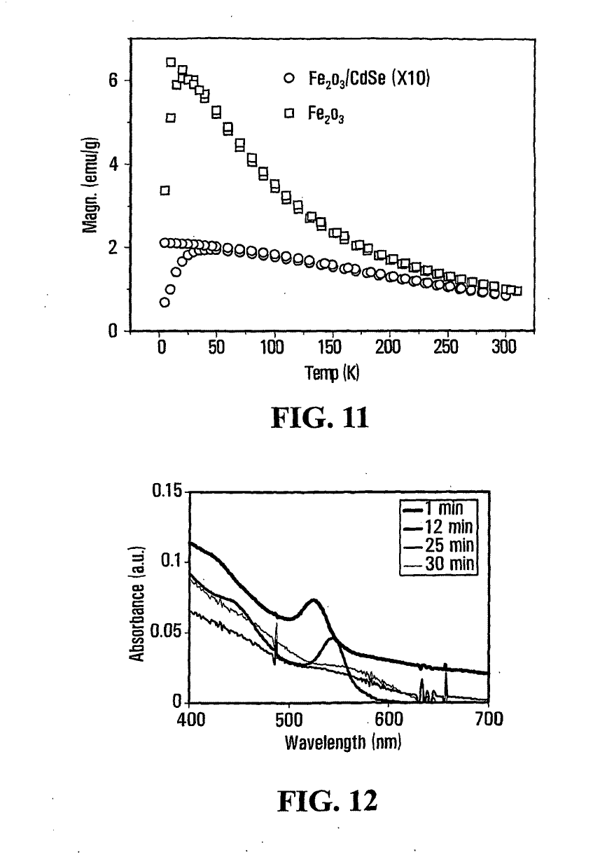

Representative zero-field-cooled (ZFC) and field-cooled (FC) magnetization curves measured at 200 Oe are shown in FIG. 11 (squares for MPs and circles for MQDs). The values for the MQD data points were multiplied by a factor of 10 for improved visual representation.

The measurement results indicated that the samples exhibited behavior characteristic of superparamagnetism with distinct blocking temperatures T_{B} of 24 K and 38 K for Fe₂O₃ MPs and Fe₂O₃—CdSe MQDs, respectively.

The variations in the observed magnetic parameters were consistent with an increase in the effective magnetic anisotropy density (K_{eff}) of the Fe₂O₃ nanoparticles when CdSe QDs were anchored onto their surface to form hybrids (as indicated by FIGS. 6 to 8).

Some of the measured absorption spectra of the sample MQDs formed with a CdO/Fe(St)₂ molar ratio of about 5:1 after the respective growth period are shown in FIG. 12. As can be seen, samples formed after a longer growth period showed absorption spectra that are not smooth, which is expected to mainly due to the attenuation by the Fe₂O₃ MPs in the composites.

The d-spacing values of the sample MPs and MQDs were measured. The measured results are listed in Table I, in comparison with values for maghemite and magnetite, which are obtained from JCPDS (Joint Committee on Powder Diffraction Standards).

Table I compares d-spacing values of as-synthesized iron oxide nanocrystals with those of the maghemite (γ-Fe₂O₃) and magnetite (Fe₃O₄) references from JCPDS.

TABLE I

| | γ-Fe₂O₃ | Fe₃O₄ | (hkl) |
|---|---|---|---|
| Sample | Reference | Reference | Planes |
| 2.954 | 2.950 | 2.970 | (220) |
| 2.482 | 2.520 | 2.530 | (311) |
| 2.225 | 2.230 | — | (321) |
| 2.085 | 2.080 | 2.097 | (400) |
| 1.703 | 1.700 | 1.714 | (422) |
| 1.603 | 1.610 | 1.615 | (511) |
| 1.473 | 1.480 | 1.484 | (440) |

As can be appreciated from the Table I, the d-spacing values of the sample iron oxide nanocrystals are close to the values of the γ-Fe₂O₃ reference material.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of forming maghemite, comprising:
oxidizing iron stearate (Fe(St)₂) with methylmorpholine N-oxide (MNO), to form maghemite (γ-Fe₂O₃).

2. The method of claim 1, wherein said oxidizing comprises heating a mixture comprising said iron stearate, said MNO, a surfactant, and a solvent to maintain said mixture at a temperature of about 280 to about 320° C. for a sufficient period to form magnetic nanoparticles comprising said maghemite; and wherein said method comprises, after said heating, cooling said mixture to limit growth in size of said nanoparticles.

3. The method of claim 2, wherein said temperature is about 300° C.

4. The method of claim 2 or claim 3, wherein said period is from about 15 to about 30 minutes.

5. The method of claim 4, wherein said period is about 15 minutes.

6. The method of claim any one of claims 2 to 5, wherein said mixture is heated under an argon gas.

7. The method of any one of claims 2 to 6, wherein said surfactant comprises octadeylamine (ODA).

8. The method of any one of claims 2 to 7, wherein said solvent is octadecene (ODE).

9. The method of any one of claims 2 to 8, wherein a weight ratio of said iron stearate to said MNO in said mixture is about 1:1 to about 2:1.

10. The method of claim 9, wherein said weight ratio of said iron stearate to said MNO in said mixture is about 2.3:1.

11. The method of any one of claims 2 to 10, wherein a weight ratio of said iron stearate to said surfactant in said mixture is about 2.3:1.

12. The method of any one of claims 2 to 11, wherein said cooling comprises cooling said mixture to a temperature of about 30 to about 40° C.

13. The method of any one of claims 2 to 12, comprising, after said cooling, washing said nanoparticles with a solution comprising cyclohexane and acetone.

14. The method of any one of claims 2 to 11, wherein said mixture further comprises cadmium stearate (Cd(St)₂).

15. The method of claim 14, wherein said surfactant comprises trioctylphosphine oxide (TOPO).

16. The method of claim 14 or claim 15, wherein said cadmium stearate is formed by reacting cadmium oxide (CdO) with a stearic acid.

17. The method of claim 16, wherein said mixture initially comprises CdO and said stearic acid, and a molar ratio of CdO to Fe(St)₂ in said mixture is from about 10:1 to about 2:1.

18. The method of claim 17, wherein said molar ratio of CdO to Fe(St)₂ in said mixture is from about 10:1 to about 5:1.

19. The method of any one of claims 14 to 18, comprising, subsequent to said cooling:
adding Selenium (Se) to said mixture to react said Cd(St)₂ with said Se to form CdSe quantum dots (QD);
dissolving said nanoparticles and said QD in a first solvent;
re-precipitating said nanoparticles and said QD in a second solvent to form a nanocomposite comprising both said maghemite and said QD.

20. The method of claim 19, wherein said temperature is about 300° C., and said cooling comprises cooling said mixture to a temperature of about 280° C.

21. The method of claim 19 or claim 20, wherein said first solvent is chloroform, and said second solvent is methanol.

22. The method of any one of claims 19 to 21, wherein said Se is dissolved in trioctylphosphine (TOP) prior to being added to said mixture.

23. A composite comprising:
a particle comprising maghemite and a CdSe quantum dot and having an average particle size of less than 100 nm,
said composite being magnetic and exhibiting a fluorescence quantum yield of above 18%.

24. The composite of claim 23, wherein said quantum yield is about 42%.

25. The composite of claim 23 or claim 24, wherein said average particle size is less than about 10 nm.

26. The composite of any one of claims 23 to 25, comprising a plurality of magnetic and fluorescent particles.

27. The composite of any one of claims 23 to 26, wherein said particle is formed according to the method of any one of claims 19 to 22.

28. Nanoparticles comprising maghemite formed according to the method of any one of claims 1 to 22.
